(19) United States
(12) Patent Application Publication
(10) Pub. No.: US 2006/0267855 A1
(43) Pub. Date: Nov. 30, 2006

(54) A Machine Producible Directive Closed-Loop Impulse Antenna

(75) Inventors: Bernt Askild Askildsen, Rapid City, SD (US); Scott Randall Thompson, Hermosa, SD (US)

Correspondence Address: RealTronics Corporation;Attn: Scott Thompson, 322 Canal Street, Rapid City, SD, 57701-2680, US

(73) Assignee: REALTRONICS CORPORATION, Rapid City, SD (US)

(21) Appl. No.: 10/908,907

(22) Filed: May 31, 2005

(51) Int. Cl. H01Q 9/16

(52) U.S. Cl. 343/793; 343/807

(57) ABSTRACT

A low-cost high performance ultra wideband antenna that combines coax-shielded cables with properly selected and carefully positioned load balancing components to form a novel closed loop dipole is disclosed. The apparatus includes a closed-loop broadband antenna circuit that may be comprised of single or multiple conductive radiating elements that are electrically connected to one another at the flare-end of each antenna leaf by at least one shielded conductor in one or more shielded cables of any type. The shielded cable portion of the closed loop circuit is interrupted by load impedance tapered regions that are positioned in an area that does not interfere or interferes minimally with antenna performance. The closed-loop broadband antenna circuit and the feed-point connections may be grounded by a separate path within the device. The disclosed approach simultaneously mitigates known problems of parasitic side lobes, antenna ringing, and RF coupling that commonly plague prior art.

### CROSS-REFERENCE TO RELATED APPLICATIONS

Current US Class: 343/793, 343/807, 343/845

International Class: H01Q 001/38, 48

Field of Search: 250/216, 342/379, 343/727, 730, 739, 740, 775, 777, 793, 795, 807, 813, 814, 815, 819, 820, 826, 828, 841, 845, 912, 913

### OTHER PUBLICATIONS

[1] R. L. Carrel, “The characteristic impedance of two infinite cones of arbitrary cross section,” IEEE Trans. Antennas Propagation, vol. AP-6, no. 2, pp. 197-201, 1958.

[2] T. T. Wu and R. W. P. King, “The Cylindrical Antenna with Nonreflecting Resistive Loading”, IEEE Transactions on Antennas and Propagation, vol. AP-13, No. 3, pp. 369-373, May 1965.

[3] Shen, “An Experimental Study of the Antenna with Nonreflecting Resistive Loading”, IEEE Transactions on Antennas and Propagation, vol. API 5, No. 5, Sep. 1967, pp. 606-611.

[4] Clapp, “A Resistively Loaded, Printed Circuit, Electrically Short Dipole Element for Wideband Array Applications”, IEEE, May 1993, pp. 478-481

[5] K. L. Shlager, G. S. Smith and J. G. Maloney, “Optimization of bow-tie antennas for pulse radiation,” IEEE Trans. Antennas Propagation, vol. 42, no. 7, pp. 975-982, 1994.

[6] Amert, T., Wolf, J., Albers, L., Palecek, D., Thompson, S., Askildsen, B., Whites, K. W., “Economical Resistive Tapering of Bowtie Antennas,” IEEE Antennas and Propagation Society Symposium, ISIU RSM, Monterey, Calif., Page(s): 1772-1775, Jun. 20-25, 2004

[7] Johnson, R. C., “Shielded-Loop Antenna”, Antenna Engineering Handbook, Third Edition, McGraw-Hill, ISBN 0-07-032381-X, p. 5-19, 1993

### STATEMENT REGARDING FEDERALLY SPONSORED RESEARCH OR DEVELOPMENT

None.

### REFERENCE TO SEQUENCE LISTING, A TABLE, OR A COMPUTER PROGRAM APPENDIX

None.

### BACKGROUND OF THE INVENTION

The challenge of specifying an optimal antenna geometry that supports a broad range of wavelengths is generally afforded at the expense of antenna ringing, polarization offsets, parasitic side-lobe generation, radiation efficiency or any combination thereof. End-fire or flare-end ringing occurs when a signal bounces back-and-forth between the feed-point and the flare end of an antenna. This is a particularly prominent problem for ultra-wideband antennas such as that described in U.S. Pat. Nos. 3,369,245 and 3,984,838 and by Carrel in [1].

A primary challenge of antenna design is to mitigate the forgoing problems without distorting the rising edge of the transmitted pulse or destabilizing the ultra wideband impedance characteristics of the antenna. Prior art employed combinations of flair end lump loading and impedance tapering to suppress end-fire ringing at the cost of rising edge distortion and poor radiation efficiency; see [2], and U.S. Pat. No. 4,679,007.

The quest for broadband antennas that are capable of effectively transmitting impulse signals or multiple carrier waves has been ongoing for nearly a half-century and is documented through prior art and public disclosure including the dipole antenna, U.S. Pat. No. 4,125,840; resistive loaded and tapered antennas, [3] and U.S. Pat. Nos. 4,642,645 and 4,803,495; printed circuit board antennas, [4] and U.S. Pat. No. 4,758,843; side-lobe suppression antennas, U.S. Pat. No. 4,376,940; and lump loading for maximal energy transfer, U.S. Pat. No. 4,679,007.

Lump loading alone does not mitigate the problem of end-fire ringing during the first several cycles and consequently target detection applications are impeded at close range. Tapered antennas address the problem of close range target detection very effectively by distributing bands of impedance across the antenna to convert the ringing energy into heat. However, this payoff is afforded at the expense of a substantial drop in radiation efficiency and an accompanying requirement for more powerful transmitter hardware. Moreover, the discrete interface at each tapered band creates parasitic side-lobes and induces reflections near the feed point that distorts the rising edge of the transmitted pulse. This is a particularly prominent problem for target identification systems because the rising edge of the pulse is used to induce reflections that carry sufficient spectral bandwidth to characterize the target. These reflections are only useful if the transmitted signal has very low levels of distortion.

More recent work by Shlager, Smith and Maloney partially addressed the problem by applying a resistive taper to bowtie antennas [5]. The devices were implemented by constructing bow-tie antenna leaves from three sections of material that were comprised of varying conductivities that followed the tapering guidelines in [2]. A continued effort by Askildsen, Thompson, Whites, et al. in 2004 expanded the applicability of resistive tapering for high-performance ultra wide band bow-tie antennas in [4]. These efforts further revealed that resistive tapering reduces the return signal of an ultra wideband (UWB) signal pulse.

Several recent designs were patented to address the deficiencies of the above listed prior art including a low side-lobe resistive reflector antenna, U.S. Pat. No. 5,134,423; a low profile antenna, U.S. Pat. No. 5,184,143; a top loaded Bow-Tie antenna, U.S. Pat. No. 6,323,821; a closely coupled directive antenna, U.S. Pat. No. 6,025,811; a tapered, folded monopole antenna, U.S. Pat. No. 6,774,858. Each of these prior disclosures employed unique methods to mitigate known problems of the expired patents that were described earlier, yet none fully and simultaneously address the problems of end-fire ringing, consistent impedance characteristics, the rising edge distortion on the transmitted pulse, parasitic side lobe generation, non-uniform polarization artifacts, radiation efficiency, or any combination thereof.

While prior art does substantially improve select antenna parameters, these methods introduce new design tradeoffs that interfere with antenna performance. This invention applies a novel approach that leverages on the principles of shielded closed loop antennas [7], ultra wide band antenna design techniques, and impedance tapering to devise an impulse antenna that mitigates the foregoing. The invention simultaneously provides efficient canceling for balanced oppositely polarized signals and safe dissipation for unbalanced signal energy.

### BRIEF SUMMARY OF THE INVENTION

This invention discloses a novel design that effectively uses conductive antenna elements and one or more matched coax cables behind the reflector back-shield to extract the performance of a slot antenna from an ultra-wideband antenna. The disclosed design also places any form of resistive loading on the outside of the back reflector shield to simultaneously mitigate antenna ringing and parasitic side-lobe generation without sacrificing radiation efficiency. The complete assembly emulates a shielded loop antenna that is typically used for continuous wave emissions; however the device is comprised of geometries that support high performance ultra-wideband dipole transmission.

### BRIEF DESCRIPTION OF SEVERAL VIEWS OF THE DRAWINGS

Electric equivalent circuits of the disclosed invention are illustrated in FIGS. 1 and 3. The disclosed invention is graphically depicted in the form of a bow-tie antenna in FIGS. 3 through 12 to illustrate the invention. However, these figures are not intended to restrict the scope of this invention to bow-tie antennas.

FIG. 1: Is an equivalent circuit for ungrounded cancellation.

FIG. 2: Is an impedance loaded antenna circuit for ungrounded cancellation.

FIG. 3: Is an equivalent circuit for grounded cancellation.

FIG. 4: Is an impedance loaded antenna circuit for grounded cancellation.

FIG. 5: Is a coax closed-loop antenna circuit without impedance loading.

FIG. 6: Is how several shielded cables are connected to an antenna leaf.

FIG. 7: Is a shielded closed-loop antenna circuit with impedance loading.

FIG. 8: Is a shielded closed-loop antenna circuit with shielded electronics.

### DETAILED DESCRIPTION OF THE INVENTION

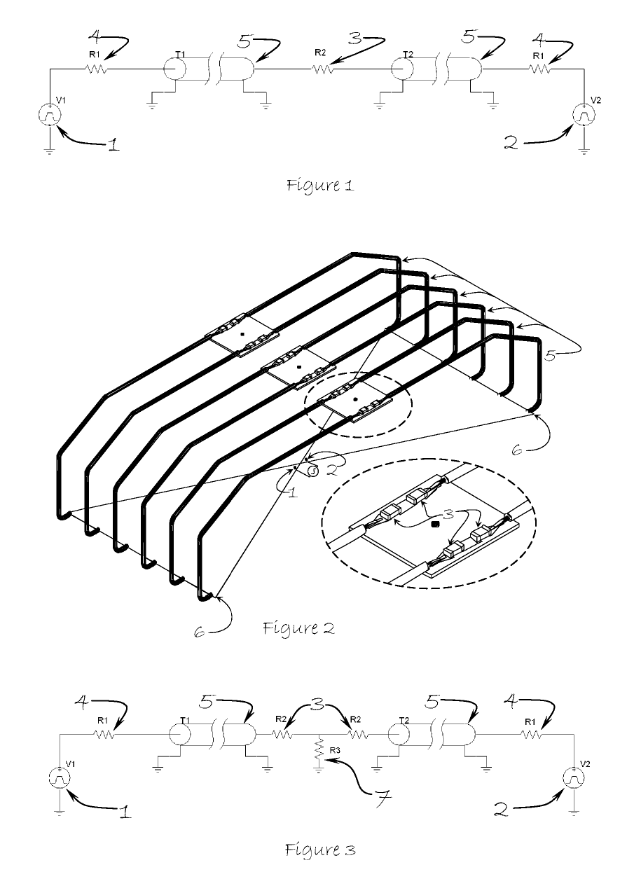

Broadband antennae are commonly energized by two matched signal generators to simultaneously couple oppositely polarized impulse signals onto the feed-points of an antenna as illustrated at 1 and 2 in FIGS. 1 through 5. Impedance mismatches at these feed point interfaces, which are typically small, and at the flare-end interfaces that are illustrated at 6 in FIGS. 2, 4, 5 and 6, which are typically large, induce reflections that rapidly deteriorate antenna performance. This is a particularly prominent problem with broadband antennas because it is difficult to design impedance interfaces that are consistent over a wide spectrum.

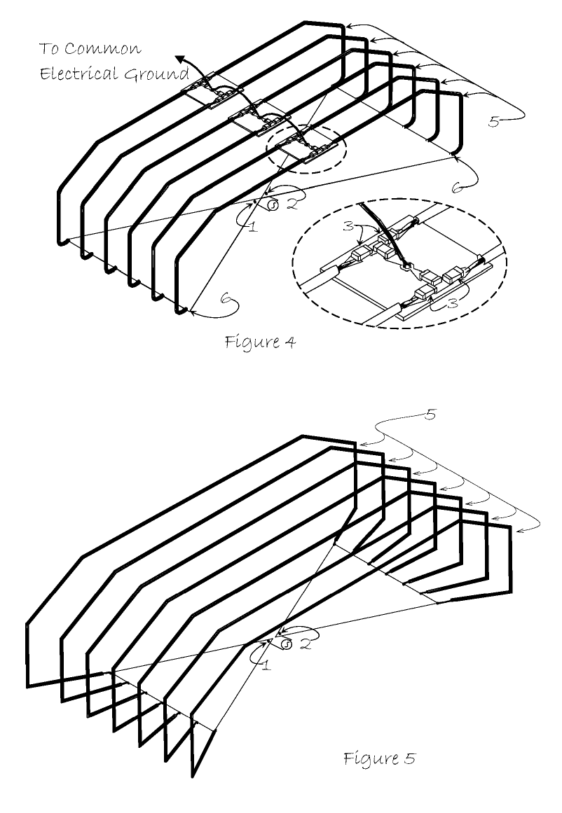

The disclosed invention uses broadband shielded cables to smoothly guide the transmitted energy away from the antenna flare end. The matched coax cables direct this energy to an assembly of impedance loads like those shown at 3 in FIGS. 1 thru 4 that facilitate energy cancellation between the oppositely polarized impulses. In an alternative embodiment of the disclosed invention like that shown in FIG. 6, the intrinsic impedance of the coax cables may be used to absorb this energy. The signal generators shown in FIGS. 1 and 2 represent the individual transmitters that supply energy to the feed point of each antenna leaf. The serial impedances R1 at 4 in FIGS. 1 and 3 represent the intrinsic impedance of each antenna leaf and are not intended to represent a specific or stand-alone component of this invention. The antenna leafs are connected in a closed circuit using shielded cables 5 that are terminated at a matched impedance R2 as illustrated at 4 in FIGS. 1 thru 5.

The antenna elements of the disclosed invention are energized by oppositely polarized pulses at 1 and 2, just like any common broadband dipole antenna. Monopole embodiments of this invention are implicitly encompassed by the spirit of this invention. These signals travel across the antenna leaves 3 and through one or more shielded coax cables 5 to dissipation impedance loads 3 where the energy is cancelled and converted to heat. A less optimal embodiment of this invention may place similar impedance tapers elsewhere on the closed-loop antenna circuit such as on the antenna leaves. An additional path to ground, which uses an impedance load at 7, provides a supplementary path to convert any remaining energy into heat. The purpose of this impedance is to dissipate any surplus energy if the generated pulses are not perfectly balanced.

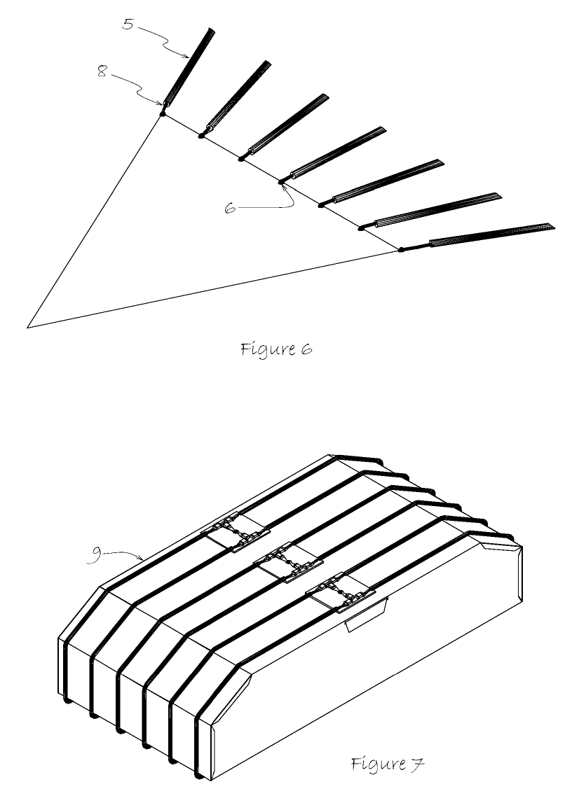

Construction of the disclosed invention is graphically illustrated in FIGS. 2 and 5 thru 8. One or more center conductors like those shown at 8 in FIG. 6 of one or more conventional impedance matched coax cables or other shielded cables are connected directly to the flare-end of the antenna at 6 in these figures; an enlarged illustration of this connection is shown at 6 in FIG. 6.

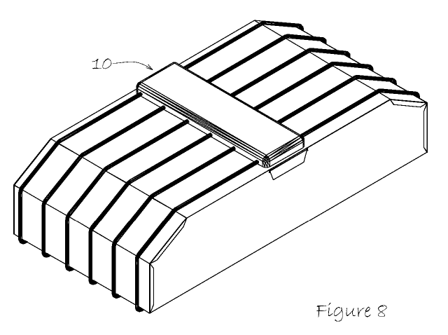

A grounded back reflector shield may be placed behind the antenna element to suppress unintentional radiation and to improve antenna directivity. In this embodiment the outer shield of each cable is connected to the antenna back-shield 9, also commonly known as the reflector, as shown in FIGS. 7 and 8. If a back reflector shield is not used, the outer shield of each cable should be electrically connected to common ground. If a given antenna is used to radiate in more than one direction or if a back-shield is not used for any other reason, the coax cables can be placed along the side of the antenna and in plane that exhibits the least amount of radiation instead of being placed along the back reflector shield. One intention of this invention is to electrically isolate the reflector back-shield from the antenna leaves to prevent side and rear lobe formation; accordingly there are no recommended fully conductive paths between the center conductive elements in the coax cables and common electrical ground or to any conductive material that is on the outside of the reflector shield. Physical placement of the shielded cables is illustrated in FIGS. 2 and 4 thru 7. Though it is not required, optimal placement of all of the shielded cables is on the outside of the back-shield. A less optimal embodiment of this invention may line the inside of the back reflector shield with the shielded cables so that they are physically placed between the reflector back shield and the antenna leaves. The energy dissipating circuits should be shielded as shown at 10 in FIG. 8 to prevent unintentional radiation.

The application of thin side shields to increase antenna directivity shown in these figures is intended to show an optimal configuration of the antenna. The side shields shown in the drawings are not intended to restrict the scope of this invention to only those antenna apparatuses with side shields. Conductive tape or soldered thin conductive foil may be affixed to the inside of the side reflectors around the antenna boundaries to prevent RF leakage; however, the addition of the same or the previously noted side shield walls are not a required component of this invention. A optional protective non-conductive coating may be applied to the outer conductive layer to strengthen the antenna apparatus.

Fully assembled embodiments of the disclosed invention are shown by example with trapezoidal reflector shield and cable profiles in FIGS. 2, 4, 5, 7 and 8. The completed assemblies shown therein comprise in part several important and functional components; namely the antenna leaves, one or more coax cables to direct RF signals to the energy dissipating circuits, optional reflector back and side shields, and the RF dissipation impedance circuits. The antenna circuit disclosed herein may comprise any shape, impedance, wave altering patterns, surface mount components, or any combination thereof.

It is possible to embody this invention in specific antenna forms and specific smooth or jagged back-shield geometries or profiles other than those described herein without departing from the spirit of the invention. Accordingly, the embodiments described in this disclosure and in the drawings are merely illustrative and should not be considered restrictive in any way. The scope of this invention is determined by the claims of this application rather than any restricting examples that comprise the preceding description. All variations and equivalents that fall within the scope of any of these claims are intended to be embraced therein.

What is claimed is:

1. Any broadband antenna that combines one or more shielded cables of any type of any type to transport any form of electromagnetic energy from the flare end of any type of broadband antenna leaf to the flare-end of another broadband antenna leaf of any type or to any type of resistive, inductive, or reactive components for the purpose of dissipating any form of unattenuated electromagnetic energy at a location that does not interfere with or interferes minimally with antenna performance and that comprises in combination:
a. one or more radiating antenna elements that are constructed of any conductive material that comprises any geometry that optimizes broadband RF transmission,
b. one or more shielded cables of any type wherein at least one shielded conductor in each cable is electrically connected at one end of the cable to the flare-end of any type of broadband radiating element and at the opposite end of the same cable to any type of impedance component,
c. one or more shielded cables of any type wherein at least one shielded conductor in each cable is electrically connected at one end of the cable to the flare-end of any type of broadband radiating element and at the opposite end of the same cable to the flare-end of another broadband radiating element of any type,
d. one or more shielded cables of any type wherein at least one shielded conductor in each cable is electrically connected at one end of the cable to the flare-end of any type of broadband radiating element and at the opposite end of the same cable to common electrical ground,
e. one or more shielded cables of any type wherein at least one shielded conductor in each cable is electrically connected at one end of the cable to the flare-end of any type of broadband radiating element and at the opposite end of the same cable to at least one shielded conductor in another shielded cable,
f. one or more electrically resistive, reactive, or inductive materials that are used to impedance balance the antenna and that are electrically connected at one end of the resistive, reactive, or inductive material to at least one shielded conductor in one or more shielded cables of any type that are connected at the opposite end of each cable to the flare end of any type of radiating antenna element and at the opposite end of the resistive, reactive, or inductive material to another resistive, reactive, or inductive material that is connected to ground,
g. one or more electrically resistive, reactive, or inductive materials that are used to impedance balance the antenna and that are electrically connected at one end of the resistive, reactive, or inductive material to at least one shielded conductor in one or more shielded coax cables that are connected to the flare end of any type of radiating antenna element wherein the opposite end of the resistive, reactive, or inductive material is connected to another resistive, reactive, or inductive material that is connected to at least one shielded conductor in a separate shielded coax cable that is connected to a separate radiating antenna element,
h. one or more electrically resistive, reactive, or inductive materials that are used to impedance balance the antenna and that are electrically connected at one end of the same material to at least one shielded conductor of one or more shielded coax cables that are connected at the opposite end of the cable to the flare end of any type of radiating antenna element and at the opposite end of the same material to another resistive, reactive, or inductive material that is connected to at least one shielded conductor in a separate shielded cable that is connected at the opposite end of the separate cable to the flare end of another radiating antenna element of any type,
i. one or more electrically resistive, reactive, or inductive materials that are used to impedance balance the antenna and that are electrically connected at one end of the same material to at least one shielded conductor in one or more shielded coax cables that are connected to the flare end of any radiating antenna element and at the opposite end of the same material to at least one shielded conductor in a separate shielded coax cable that is connected to the flare-end of another radiating antenna element of any type,
j. any combination of the presence or absence of one or more electrically resistive, inductive, and capacitive materials that are used to impedance balance the antenna and that are electrically connected to any shielded coax cable that is connected to any antenna radiating element,
k. any combination of the presence or absence of one or more electrically resistive, inductive, and capacitive materials that are used to impedance balance the antenna and that are electrically connected to any shielded coax cable that is connected to common electrical ground,
l. any combination of the presence or absence of one or more electrically resistive, inductive, and capacitive materials that are used to impedance balance the antenna and that are electrically connected to any shielded coax cable that is connected to any other impedance balancing material,
m. any combination of the presence or absence of one or more electrically resistive, inductive, and capacitive materials that are used as energy dissipating components and that are electrically connected to at least one shielded conductor in any shielded cable that is electrically connected to any radiating antenna element,
n. any combination of the presence or absence of one or more electrically resistive, inductive, and capacitive materials that are used as energy dissipating components and that are electrically connected to at least one shielded conductor in any shielded cable at one end of the same material and that is electrically connected to common electrical ground at the other end of the same material,
o. any combination of the presence or absence of one or more electrically resistive, inductive, and capacitive materials that are used to impedance balance the antenna and that are electrically connected to any material that is used to incorporate energy dissipating components into the antenna apparatus,
p. one or more electrically resistive materials that are used to impedance balance the antenna and are placed anywhere on the closed loop antenna circuit,
q. one or more electrically reactive materials that are used to impedance balance the antenna and are placed anywhere on the closed loop antenna circuit,
r. one or more electrically inductive materials that are used to impedance balance the antenna and are placed anywhere on the closed loop antenna circuit,
s. any combination of the presence or absence of one or more electrically resistive, and inductive materials that are used to impedance balance the antenna and are placed anywhere on the closed loop antenna circuit,
t. any combination of the presence or absence of conductive tape, solder, rivets, or other conductive materials that are used to prevent RF leakage around the antenna apparatus,
u. any conductive material that is used to form a shield around any impedance balancing component to prevent unintentional radiation,
v. any conductive material that is used to form a shield around any energy dissipating component to prevent unintentional radiation,
w. any conductive material that is used to form a shield around any electrical connection at the ends of any shielded cable, energy dissipating component, or impedance balancing component to prevent unintentional radiation.

2. Any broadband antenna of the type in claim 1 that uses one or more coax cables to form and hence to replace a back reflector shield.

3. Any broadband antenna of the type in claim 1 and claim 2 that uses any type of one or more shielded cables of any type that are used to redirect energy from the intentional radiating elements of any broadband antenna too any resistive, reactive, or inductive load that is physically located elsewhere on the antenna apparatus so that any unspent electromagnetic energy that was used to energize the antenna is dissipated at a location that does not interfere with or interferes minimally with intentional signals on the antenna and that comprises in combination:
a. any type of shielded cable assembly of the type in claim 1 that redirects energy from the antenna elements to any impedance load wherein the outer electrical shield of the cable is electrically connected to the reflector shield,
b. any type of shielded cable assembly of the type in claim 1 that redirects energy from the antenna elements to any impedance load wherein the outer electrical shield of the cable is electrically connected to common electrical ground,
c. the presence or absence of any electrical connection between the outer electrical shield of any shielded cable of the type in (a) and (b) of this claim and the back reflector shield,
d. the presence or absence of any electrical connection between the outer electrical shield of any shielded cable of the type in (a) and (b) of this claim and common electrical ground.

4. Any broadband antenna apparatus of the type in claim 1 and claim 2 that comprises in combination:
a. any conductive material that is affixed to the sides of the antenna apparatus to improve the directivity of the antenna,
b. any impedance tapered material that is affixed to the sides of the antenna apparatus to improve the directivity of the antenna,
c. any conductive material that is affixed to the sides of the antenna apparatus to suppress unintentional radiation,
d. any impedance tapered material that is affixed to the sides of the antenna apparatus to suppress unintentional radiation,
e. any type of impedance tapered broadband antenna elements,
f. any type of broadband antenna elements that are impedance loaded at the flare-ends,
g. any type of fully conductive broadband antenna elements,
h. any type of impedance tapered reflector shield,
i. any type of fully conductive reflector shield,
j. any type of lump-impedance loaded conductive reflector shield,
k. any type of impedance cancellation network to dissipate any form of unspent RF energy,
l. any impedance cancellation network to mitigate side lobes and antenna ringing.

5. Any broadband antenna apparatus of the type in claim 1 that comprises in combination:
a. any broadband antenna of any geometric shape,
b. any broadband antenna of any geometric profile,
c. any reflector back-shield of any geometric shape,
d. any reflector back-shield of any geometric profile,
e. any non-conductive protective coating or material on or around the antenna leaves,
f. any non-conductive protective coating or material on or around the reflector back-shield,
g. Any material that is used to strengthen the physical structure of any antenna of the type in claim 1.
